(19) United States
(12) Patent Application Publication
(10) Pub. No.: US 2017/0373793 A1
(43) Pub. Date: Dec. 28, 2017

(54) TECHNIQUES FOR MANAGING BLIND DECODING REDUCTION FOR CONTROL CHANNEL SEARCH SPACES

(71) Applicant: QUALCOMM Incorporated, San Diego, CA (US)

(72) Inventors: Srinivas YERRAMALLI, San Diego, CA (US); Wanshi CHEN, San Diego, CA (US); Peter GAAL, San Diego, CA (US)

(21) Appl. No.: 15/615,481

(22) Filed: Jun. 6, 2017

Related U.S. Application Data
(60) Provisional application No. 62/354,574, filed on Jun. 24, 2016.

(51) Int. Cl. H04L 1/00; H04L 27/26; H04L 5/00; H04W 72/04

(52) U.S. Cl. CPC H04L 1/0038; H04W 72/042; H04L 27/2607; H04L 5/001; H04L 5/0048; H04L 5/0041; H04L 5/0094

(57) ABSTRACT

Aspects described herein relate to managing blind decoding of a control channel search space. A number of blind decodes configured for a control channel search space can be determined based at least in part on one or more parameters broadcasted by a access point that transmits a control channel in the control channel search space. One or more reduction values can be determined for the number of blind decodes at the UE. A pattern for performing a subset of the number of blind decodes can be determined based at least in part on the one or more reduction values. Blind decoding can be performed for the control channel based on the pattern for performing the subset of the number of blind decodes to obtain control data transmitted in the control channel.

### CLAIM OF PRIORITY UNDER 35 U.S.C. §119

The present application for Patent claims priority to Provisional Application No. 62/354,574, entitled “TECHNIQUES FOR MANAGING BLIND DECODING REDUCTION FOR CONTROL CHANNEL SEARCH SPACES” filed Jun. 24, 2016, which is assigned to the assignee hereof and hereby expressly incorporated by reference herein for all purposes.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple user equipment devices. Each user equipment (UE) communicates with one or more base stations, such as an evolved Node B (eNB), via transmissions on the forward and reverse links. The forward link (or downlink) refers to the communication link from the eNBs to the UEs, and the reverse link (or uplink) refers to the communication link from the UEs to the eNBs. This communication link may be established via a single-in-single-out, multiple-in-single-out or a multiple-in-multiple-out (MIMO) system. In this regard, the UEs can access wireless network via one or more eNBs.

In LTE, UEs communicating with eNBs can be configured with parameters for searching for a physical downlink control channel (PDCCH) from the eNBs in a common search space (CSS) or a UE-specific search space (UESS). The CSS or UESS can correspond to portions of frequency and/or time resources over which the eNB transmits control data for discovery by one or more UEs. The CSS can carry downlink control data that is common for all UEs, and the USS can carry downlink control data for UE-specific allocations using one or more radio network temporary identifiers (RNTI) assigned to a given UE. For example, the parameters configured for searching the CSS/UESS for PDCCH may include an aggregation level. Based on the parameters, the UE can perform blind decoding of a search space in an attempt to decode the PDCCH from the eNB. Each parameter value (e.g., aggregation level) may have multiple associated blind decoding candidates, and each candidate may have multiple possible sizes, which can result in a large number of blind decodes (e.g., 32 or 48 for some aggregation levels). In addition, additional blind decoding candidates may be configured where an eNB may allow various downlink control indicator (DCI) formats to be used in the PDCCH/EPDCCH. As the number of blind decoding possibilities increase, the efficiency of using blinding decoding for the PDCCH/EPDCCH may become ineffective.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for wireless communication by a user equipment (UE) is provided. The method includes determining a number of blind decodes configured for a control channel search space based at least in part on one or more parameters broadcasted by an access point that transmits a control channel in the control channel search space, determining one or more reduction values for the number of blind decodes at the UE, and determining a pattern for performing a subset of the number of blind decodes based at least in part on the one or more reduction values. The method further includes performing, by the UE, blind decoding for the control channel based on the pattern for performing the subset of the number of blind decodes to obtain control data transmitted in the control channel.

In another example, an apparatus for wireless communications is provided that includes a transceiver for communicating one or more wireless signals via one or more antennas, a memory configured to store instructions, and one or more processors communicatively coupled with the transceiver and the memory. The one or more processors are configured to determine a number of blind decodes configured for a control channel search space based at least in part on one or more parameters broadcasted by an access point that transmits a control channel in the control channel search space, determine one or more reduction values for the number of blind decodes at the UE, determine a pattern for performing a subset of the number of blind decodes based at least in part on the one or more reduction values, and perform blind decoding for the control channel based on the pattern for performing the subset of the number of blind decodes to obtain control data transmitted in the control channel

In other aspects, a method for wireless communication by an access point is provided. The method includes configuring one or more parameters related to a number of blind decodes for a control channel search space for a UE, indicating one or more reduction values for the number of blind decodes, indicating one or more additional parameters related to a pattern for performing a subset of the number of blind decodes based at least in part on the one or more reduction values, and transmitting a control channel in the control channel search space based on a downlink control information (DCI) format corresponding to at least one of the subset of the number of blind decodes.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows a block diagram conceptually illustrating an example of a telecommunications system, in accordance with aspects described herein.

FIG. 2 is a diagram illustrating an example of an access network.

FIG. 3 is a diagram illustrating an example of an evolved Node B and user equipment in an access network.

FIG. 4 illustrates an example of a system for managing blind decoding of a control channel search space in wireless communications in accordance with aspects described herein.

FIG. 5 illustrates an example of a method for performing blind decoding of a control channel search space in accordance with aspects described herein.

FIG. 6 illustrates an example of a method for transmitting a control channel in a control channel search space in accordance with aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described herein are various aspects related to managing blind decoding reduction in control channel search spaces. A control channel search space can include a portion of frequency resources (e.g., frequency band, number of resource blocks, etc.) over which a control channel is transmitted. The portion of frequency resources (and/or a portion of time, such as one or more subframes, symbols of a subframe, etc.) can be known, configured, or otherwise detected by a device (e.g., a UE) to allow the device to search the search space for control channel communications. For example, the device can perform blind decoding of the control channel search space based on a plurality of blind decoding candidates to determine whether one of the blind decoding candidates allows for successful decoding of a control channel received in the control channel search space. In an example, the number of blind decodes that can be performed by the device can be determined based on one or more configured or known parameters of the control channel search space (e.g., an aggregation level of the control channel search space, a number of possible control channel sizes, a number of possible downlink control information (DCI) formats that can be used for the control channel, etc.). In an example, the parameters can be configured for the device by a node transmitting the control channel in the search space (e.g., an evolved Node B (eNB)). The device can attempt to decode the control channel using each of the blind decoding candidates, for example, by using a radio network temporary identifier (RNTI) assigned to the device in an attempt to demask a cyclic redundancy check (CRC) of a given blind decoding candidate.

In an example, a number of blind decodes for a search space can be reduced based on one or more parameters received for a control channel search space to lessen the complexity of blind decoding, and/or a pattern for performing the reduced number of blind decodes can be determined to increase effectiveness of the blind decoding. For example, the pattern may include linearly arranging the reduced number of blind decodes according to DCI format, offsetting the linearly arranged pattern of the reduced number of blind decodes (e.g., based on a received offset parameter), arranging the reduced number of blind decodes in a configured order according to DCI format, interleaving the reduced number of blind decodes based on a corresponding DCI format, etc. In addition, for example, the pattern can be determined for each of multiple configured aggregation levels in the control channel search space. In one example, a network device, such as an eNB, can signal configuration of a set of the blind decoding candidates, DCI formats for each set of candidates, a pattern for the set of the candidates, etc., to another device, such as the UE. Moreover, in an example, multiple RNTIs can be assigned, and the set of candidates may be split among the multiple RNTIs (e.g., candidates for downlink control channel can be assigned to one RNTI while candidates for uplink control channel can be assigned to another RNTI). In any case, reduction of blind decoding in the control channel search spaces can be effectively managed.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, user equipment, or user equipment device. A wireless terminal can be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with an access point, such as a base station. A base station can be utilized for communicating with wireless terminal(s) and can also be referred to as an access point, access node, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (WiFi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN (WLAN), BLUETOOTH and any other short- or long-range, wireless communication techniques.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

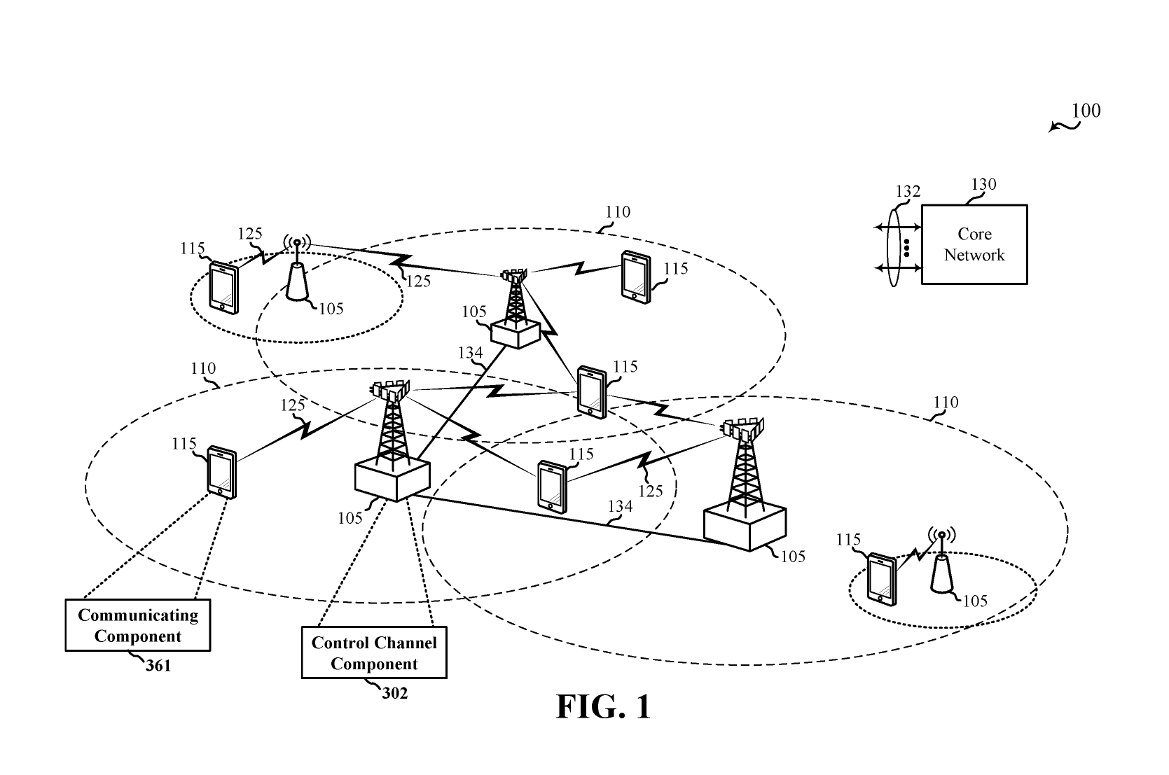

Referring first to FIG. 1, a diagram illustrates an example of a wireless communications system 100, in accordance with aspects described herein. The wireless communications system 100 includes a plurality of access points (e.g., base stations, eNBs, or WLAN access points) 105, a number of user equipment (UEs) 115, and a core network 130. One or more of access points 105 can include a control channel component 302 for communicating a control channel to one or more UEs 115. One or more of UEs 115 can include a communicating component 361 for communicating with the one or more access points 105 to receive and decode one or more control channels.

Some of the access points 105 may communicate with the UEs 115 under the control of a base station controller (not shown), which may be part of the core network 130 or the certain access points 105 (e.g., base stations or eNBs) in various examples. Access points 105 may communicate control information and/or user data with the core network 130 through backhaul links 132. In examples, the access points 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each of the communication links 125 may be a multi-carrier signal modulated according to the various radio technologies described above. Each modulated signal may be sent on a different carrier and may carry control information (e.g., reference signals, control channels, etc.), overhead information, data, etc.

In this regard, a UE 115 can be configured to communicate with one or more access points 105 over multiple carriers using carrier aggregation (CA) (e.g., with one access point 105) and/or multiple connectivity (e.g., with multiple access points 105). In either case, the UE 115 can be configured with at least one primary cell (PCell) configured to support uplink and downlink communications between the UE 115 and an access point 105. In an example, there can be a PCell for each of the communication links 125 between a UE 115 and a given access point 105. In addition, each of the communication links 125 can have one or more secondary cells (SCell) that can support uplink and/or downlink communications as well. In some examples, the PCell can be used to communicate at least a control channel, and the SCell can be used to communicate a data channel.

The access points 105 may wirelessly communicate with the UEs 115 via one or more access point antennas. Each of the access points 105 sites may provide communication coverage for a respective coverage area 110. In some examples, the access points 105 may be referred to as a base transceiver station, a radio base station, a radio transceiver, a basic service set (BSS), an extended service set (ESS), a NodeB, eNodeB, Home NodeB, a Home eNodeB, or some other suitable terminology. The coverage area 110 for a base station may be divided into sectors making up only a portion of the coverage area (not shown). The wireless communications system 100 may include access points 105 of different types (e.g., macro, micro, and/or pico base stations). The access points 105 may also utilize different radio technologies, such as cellular and/or WLAN radio access technologies (RAT). The access points 105 may be associated with the same or different access networks or operator deployments. The coverage areas of different access points 105, including the coverage areas of the same or different types of access points 105, utilizing the same or different radio technologies, and/or belonging to the same or different access networks, may overlap.

In LTE/LTE-A network communication systems, the terms evolved Node B (eNodeB or eNB) may be generally used to describe the access points 105. The wireless communications system 100 may be a Heterogeneous LTE/LTE-A network in which different types of access points provide coverage for various geographical regions. For example, each access point 105 may provide communication coverage for a macro cell, a pico cell, a femto cell, and/or other types of cell. Small cells such as pico cells, femto cells, and/or other types of cells may include low power nodes or LPNs. A macro cell may cover a relatively large geographic area (e.g., several kilometers in radius) and may allow unrestricted access by UEs 115 with service subscriptions with the network provider. A small cell may cover a relatively smaller geographic area and may allow unrestricted access by UEs 115 with service subscriptions with the network provider, for example. In addition or alternatively to unrestricted access, a small cell may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells. The term “eNB”, as used generally herein, may relate to a macro eNB and/or a small cell eNB.

In an example, a small cell may operate in an “unlicensed” frequency band or spectrum, which can refer to a portion of radio frequency (RF) space that is not licensed for use by one or more wireless wide area network (WWAN) technologies, but may or may not be used by other communication technologies (e.g., wireless local area network (WLAN) technologies, such as Wi-Fi). Moreover, a network or device that provides, adapts, or extends its operations for use in an “unlicensed” frequency band or spectrum may refer to a network or device that is configured to operate in a contention-based radio frequency band or spectrum. In addition, for illustration purposes, the description below may refer in some respects to an LTE system operating on an unlicensed band by way of example when appropriate, although, in an example, such descriptions are not intended to exclude other cellular communication technologies. LTE on an unlicensed band may also be referred to herein as LTE/LTE-Advanced in unlicensed spectrum, or simply LTE, in the surrounding context.

The core network 130 may communicate with the eNBs or other access points 105 via a backhaul links 132 (e.g., Si interface, etc.). The access points 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time. Furthermore, transmissions in a first hierarchical layer and a second hierarchical layer (or additional hierarchical layers) may or may not be synchronized among access points 105. The techniques described herein may be used for either synchronous or asynchronous operations.

The UEs 115 are dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with an access point, such as macro eNodeBs, small cell eNodeBs, relays, and the like. A UE 115 may also be able to communicate over different access networks, such as cellular or other WWAN access networks, or WLAN access networks.

The communication links 125 shown in wireless communications system 100 may include uplink (UL) transmissions from a UE 115 to an access point 105, and/or downlink (DL) transmissions, from an access point 105 to a UE 115. The downlink transmissions may also be called forward link transmissions while the uplink transmissions may also be called reverse link transmissions. The communication links 125 may carry transmissions of each hierarchical layer which, in some examples, may be multiplexed in the communication links 125. The UEs 115 may be configured to collaboratively communicate with multiple access points 105 through, for example, Multiple Input Multiple Output (MIMO), carrier aggregation (CA), Coordinated Multi-Point (CoMP), multiple connectivity (e.g., CA with each of one or more access points 105) or other schemes. MIMO techniques use multiple antennas on the access points 105 and/or multiple antennas on the UEs 115 to transmit multiple data streams. Carrier aggregation may utilize two or more component carriers on a same or different serving cell for data transmission. CoMP may include techniques for coordination of transmission and reception by a number of access points 105 to improve overall transmission quality for the UEs 115 as well as increasing network and spectrum utilization.

As mentioned, in some examples the access points 105 and UEs 115 may utilize carrier aggregation to transmit on multiple carriers. In some examples, the access points 105 and UEs 115 may concurrently transmit in a first hierarchical layer, within a frame, one or more subframes each having a first subframe type using two or more separate carriers. Each carrier may have a bandwidth of, for example, 20 MHz, although other bandwidths may be utilized. For example, if four separate 20 MHz carriers are used in a carrier aggregation scheme in the first hierarchical layer, a single 80 MHz carrier may be used in the second hierarchical layer. The 80 MHz carrier may occupy a portion of the radio frequency spectrum that at least partially overlaps the radio frequency spectrum used by one or more of the four 20 MHz carriers. In some examples, scalable bandwidth for the second hierarchical layer type may be combined techniques to provide shorter round trip times such as described above, to provide further enhanced data rates.

Each of the different operating modes that may be employed by wireless communications system 100 may operate according to frequency division duplexing (FDD) or time division duplexing (TDD). In some examples, different hierarchical layers may operate according to different TDD or FDD modes. For example, a first hierarchical layer may operate according to FDD while a second hierarchical layer may operate according to TDD. In some examples, OFDMA communications signals may be used in the communication links 125 for LTE downlink transmissions for each hierarchical layer, while single carrier frequency division multiple access (SC-FDMA) communications signals may be used in the communication links 125 for LTE uplink transmissions in each hierarchical layer.

In an example, a UE 115 may communicate with a serving access point 105 via communicating component 361 to receive and decode a control channel generated by control channel component 302. For example, communicating component 361 may perform blind decoding over a search space defined for the control channel, which may be based on parameters indicated by the access point 105 for the search space and/or related to a number of blind decodes or a reduction in the number of blind decodes to be performed. As described further herein, communicating component 361 can determine a pattern for performing a reduced number of blind decodes to improve efficiency of the blind decoding, which may be based on one or more parameters received from the access point (e.g., from control channel component 302). For example, the one or more parameters may include an offset of a linear pattern of the blind decodes based on DCI format, an order for performing the blind decodes based on DCI format, an interleaving of the blind decodes based on DCI format, etc.

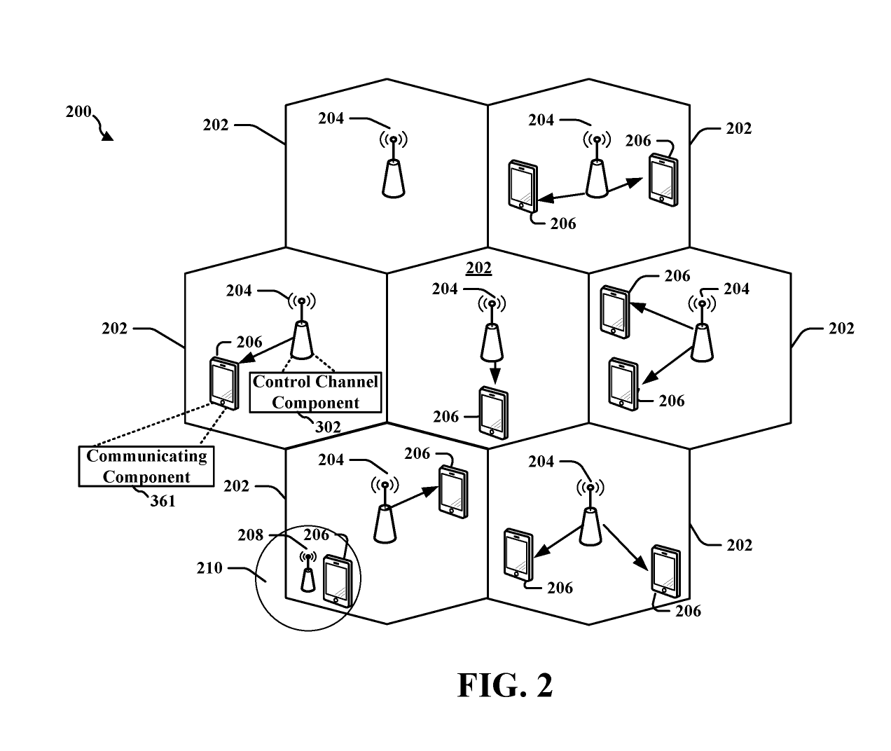

FIG. 2 is a diagram illustrating an example of an access network 200 in an LTE network architecture. In this example, the access network 200 is divided into a number of cellular regions (cells) 202. One or more small cell eNBs 208 may have cellular regions 210 that overlap with one or more of the cells 202. The small cell eNBs 208 may be of a lower power class (e.g., home eNB (HeNB)), femto cell pico cell, micro cell, or remote radio head (RRH). The macro eNBs 204 are each assigned to a respective cell 202 and are configured to provide an access point to the core network 130 for all the UEs 206 in the cell 202. In an aspect, one or more of eNBs 204, small cell eNBs 208, etc. can include a control channel component 302 for communicating a control channel to one or more UEs 206. One or more of the UEs 206 can include a communicating component 361 for communicating with the one or more eNBs 204, 208 to receive and decode one or more control channels. There is no centralized controller shown in this example of an access network 200, but a centralized controller may be used in alternative configurations. The eNBs 204 can be responsible for radio related functions including radio bearer control, admission control, mobility control, scheduling, security, and connectivity to a serving gateway.

The modulation and multiple access scheme employed by the access network 200 may vary depending on the particular telecommunications standard being deployed. In LTE applications, OFDM may be used on the DL and SC-FDMA may be used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204, 208 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204, 208 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

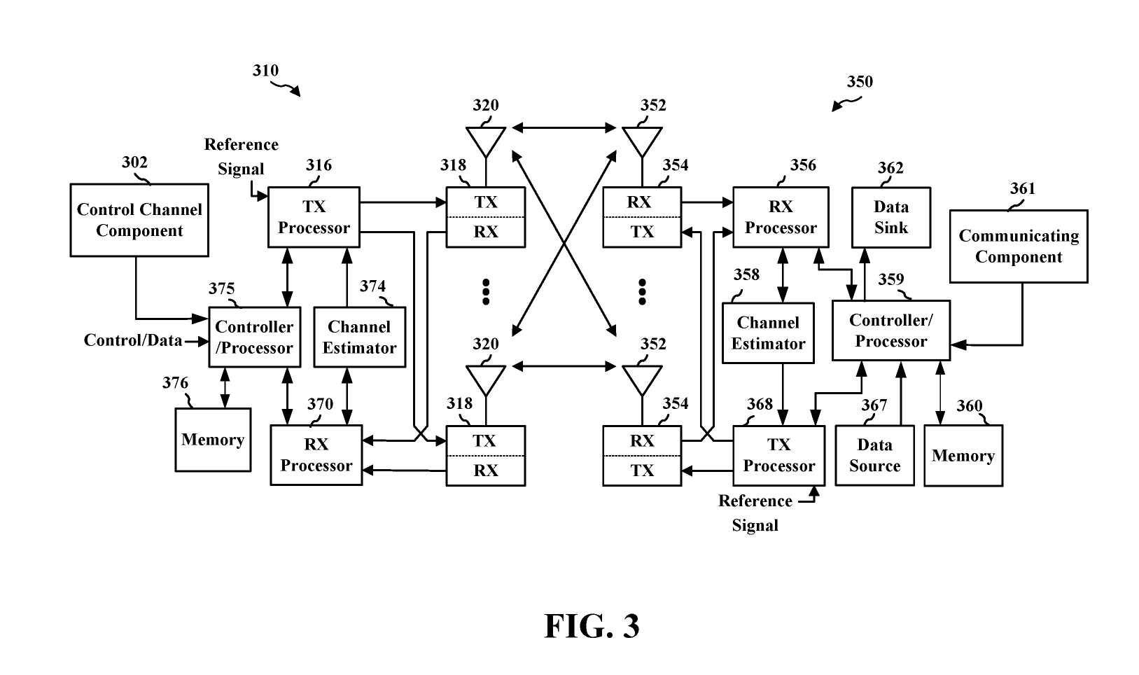

FIG. 3 is a block diagram of an eNB 310 in communication with a UE 350 in an access network. In the DL, upper layer packets from the core network are provided to a controller/processor 375. The controller/processor 375 implements the functionality of the L2 layer. In the DL, the controller/processor 375 provides header compression, ciphering, packet segmentation and reordering, multiplexing between logical and transport channels, and radio resource allocations to the UE 350 based on various priority metrics. The controller/processor 375 is also responsible for hybrid automatic repeat/request (HARD) operations, retransmission of lost packets, and signaling to the UE 350.

The transmit (TX) processor 316 implements various signal processing functions for the L1 layer (i.e., physical layer). The signal processing functions includes coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream is then provided to a different antenna 320 via a separate transmitter 318TX. Each transmitter 318TX modulates an RF carrier with a respective spatial stream for transmission. The eNB 310 can include a control channel component 302 for communicating a control channel to one or more UEs 350. Though the control channel component 302 is shown as coupled to the controller/processor 375, in an example, control channel component 302 can also be communicatively coupled with other processors (e.g., TX processor 316, RX processor 370, etc.) and/or implemented by the one or more processors 316, 375, 370 to perform actions described herein.

At the UE 350, each receiver 354RX receives a signal through its respective antenna 352. Each receiver 354RX recovers information modulated onto an RF carrier and provides the information to the receive (RX) processor 356. The RX processor 356 implements various signal processing functions of the L1 layer. The RX processor 356 performs spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 310. These soft decisions may be based on channel estimates computed by the channel estimator 358. The soft decisions are then decoded and deinterleaved to recover the data and control signals that were originally transmitted by the eNB 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the controller/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations. In addition, the UE 350 may include a communicating component 361 for communicating with the one or more eNBs 310 to receive and decode one or more control channels. Though the communicating component 361 is shown as coupled to the controller/processor 359, in an example, the communicating component 361 can also be communicatively coupled with other processors (e.g., RX processor 356, TX processor 368, etc.) and/or implemented by the one or more processors 356, 359, 368 to perform actions described herein.

In the UL, a data source 367 is used to provide upper layer packets to the controller/processor 359. The data source 367 represents all protocol layers above the L2 layer. Similar to the functionality described in connection with the DL transmission by the eNB 310, the controller/processor 359 implements the L2 layer for the user plane and the control plane by providing header compression, ciphering, packet segmentation and reordering, and multiplexing between logical and transport channels based on radio resource allocations by the eNB 310. The controller/processor 359 is also responsible for HARQ operations, retransmission of lost packets, and signaling to the eNB 310.

Channel estimates derived by a channel estimator 358 from a reference signal or feedback transmitted by the eNB 310 may be used by the TX processor 368 to select the appropriate coding and modulation schemes, and to facilitate spatial processing. The spatial streams generated by the TX processor 368 are provided to different antenna 352 via separate transmitters 354TX. Each transmitter 354TX modulates an RF carrier with a respective spatial stream for transmission.

The UL transmission is processed at the eNB 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the L1 layer.

The controller/processor 375 implements the L2 layer. The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

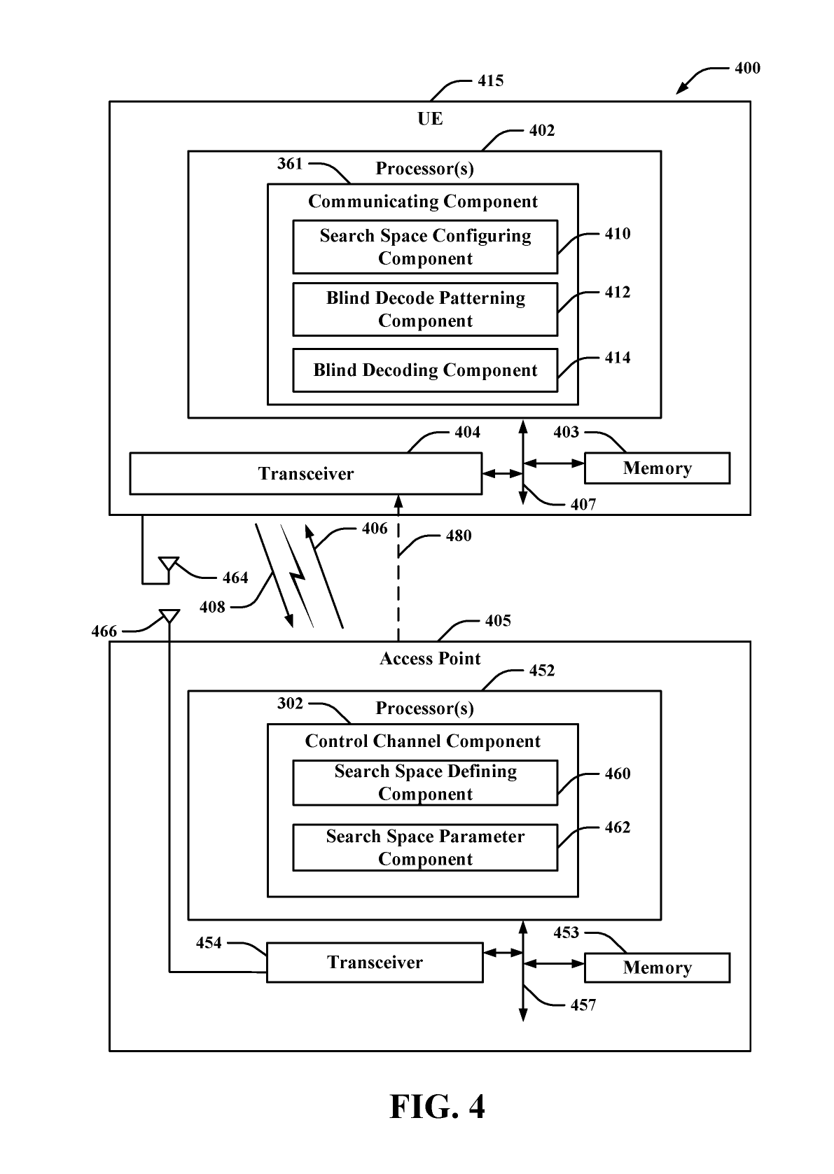

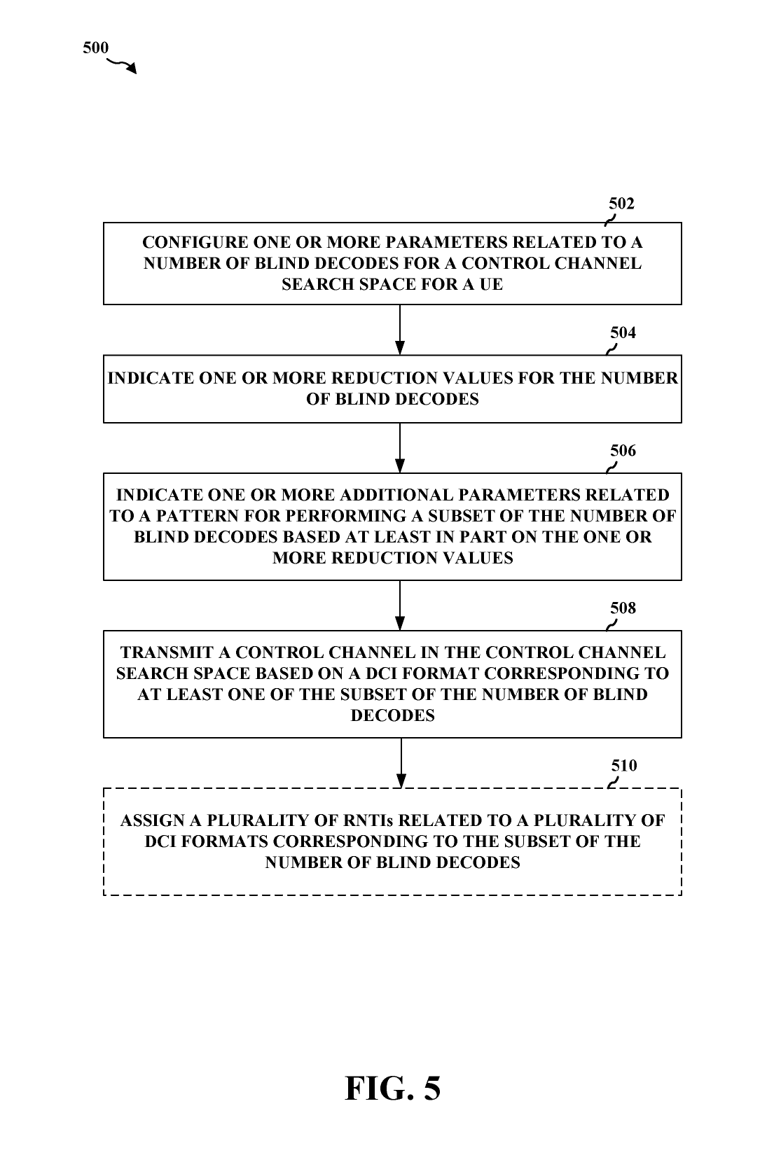

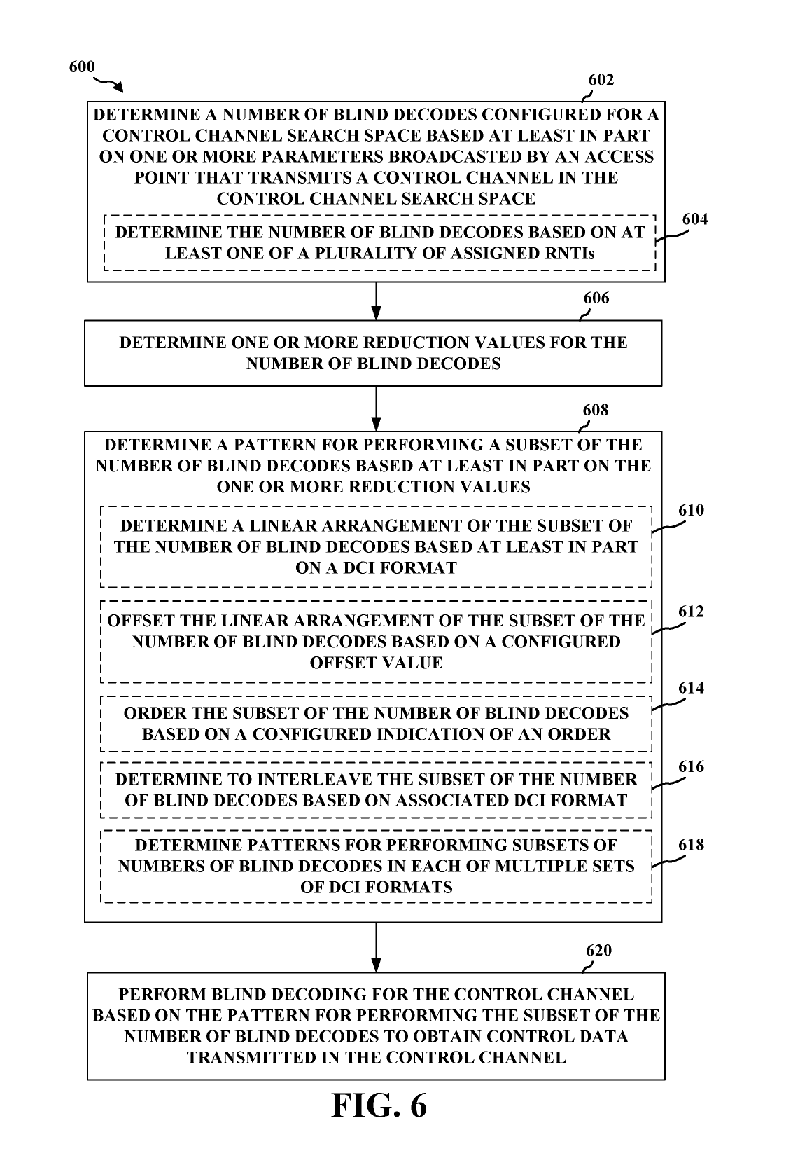

Turning now to FIGS. 4-6, aspects are depicted with reference to one or more components and one or more methods that may perform the actions or operations described herein, where aspects in dashed line may be optional. Although the operations described below in FIGS. 5-6 are presented in a particular order and/or as being performed by an example component, it should be understood that the ordering of the actions and the components performing the actions may be varied, depending on the implementation. Moreover, it should be understood that the following actions, functions, and/or described components may be performed by a specially-programmed processor, a processor executing specially-programmed software or computer-readable media, or by any other combination of a hardware component and/or a software component capable of performing the described actions or functions.

FIG. 4 depicts an example of a system 400 for performing blind decoding over one or more search spaces in accordance with aspects described herein. The system 400 includes a UE 415 that communicates with an access point 405 to access a wireless network, examples of which are described in FIGS. 1-3 above (e.g., UEs 115, 206, 350, access points/eNBs 105, 204, 208, 310, etc.). In an aspect, one or more downlink signals 406 can be transmitted by the access point 405 (e.g., via access point transceiver 454) and received by the UE 415 (e.g., via UE transceiver 404) for communicating control and/or data messages (e.g., signaling) from the access point 405 to the UE 415 over a control channel search space, configured communication resources, etc. Moreover, for example, one or more uplink signals 408 can be transmitted by the UE 415 (e.g., via UE transceiver 404) and received by the access point 405 (e.g., via access point transceiver 454) for communicating control and/or data messages (e.g., signaling) from the UE 415 to the access point 405 over configured communication resources. In one example, the access point 405 may transmit a signal 480, which may include a control channel such as PDCCH/EPDCCH, in a control channel search space, which may include a common search space (CSS) for a plurality of UEs, a UE-specific search space (DESS) specific to UE 415, etc.

In an aspect, UE 415 may include one or more processors 402 and/or memory 403 that may be communicatively coupled, e.g., via one or more buses 407, and may operate in conjunction with or otherwise implement a communicating component 361 for communicating with the one or more access points, such as access point 405, to receive and decode one or more control channels. For example, the various operations related to the communicating component 361 may be implemented or otherwise executed by one or more processors 402 and, in an aspect, can be executed by a single processor, while in other aspects, different ones of the operations may be executed by a combination of two or more different processors. For example, in an aspect, the one or more processors 402 may include any one or any combination of a modem processor, or a baseband processor, or a digital signal processor, or an application specific integrated circuit (ASIC), or a transmit processor, or a transceiver processor associated with UE transceiver 404. Further, for example, the memory 403 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 402. Moreover, the memory 403 or computer-readable storage medium may be resident in the one or more processors 402, external to the one or more processors 402, distributed across multiple entities including the one or more processors 402, etc.

In particular, the one or more processors 402 and/or memory 403 may execute actions or operations defined by communicating component 361 or its subcomponents. For instance, the one or more processors 402 and/or memory 403 may execute actions or operations defined by a search space configuring component 410 for determining one or more parameters related to a configuration of a control channel search space (or other channel search space), such as a CSS, DESS, etc., transmitted by an access point. In an aspect, for example, search space configuring component 410 may include hardware (e.g., one or more processor modules of the one or more processors 402) and/or computer-readable code or instructions stored in memory 403 and executable by at least one of the one or more processors 402 to perform the specially configured search space configuring operations described herein. Further, for instance, the one or more processors 402 and/or memory 403 may execute actions or operations defined by a blind decode patterning component 412 for determining a pattern for performing a reduced number of blind decodes of the search space in an attempt to decode the control channel. In an aspect, for example, the blind decode patterning component 412 may include hardware (e.g., one or more processor modules of the one or more processors 402) and/or computer-readable code or instructions stored in memory 403 and executable by at least one of the one or more processors 402 to perform the specially configured blind decode patterning operations described herein. Further, for instance, the one or more processors 402 and/or memory 403 may execute actions or operations defined by a blind decoding component 414 for performing the reduced number of blind decodes of the search space according to the pattern in an attempt to decode the control channel. In an aspect, for example, the blind decoding component 414 may include hardware (e.g., one or more processor modules of the one or more processors 402) and/or computer-readable code or instructions stored in memory 403 and executable by at least one of the one or more processors 402 to perform the specially configured blind decoding operations described herein.

Similarly, in an aspect, the access point 405 may include one or more processors 452 and/or memory 453 that may be communicatively coupled, e.g., via one or more buses 457, and may operate in conjunction with or otherwise implement a control channel component 302 for generating a control channel for transmitting in a corresponding search space. For example, the various functions related to the control channel component 302 may be implemented or otherwise executed by one or more processors 452 and, in an aspect, can be executed by a single processor, while in other aspects, different ones of the functions may be executed by a combination of two or more different processors, as described above. In one example, the one or more processors 452 and/or memory 453 may be configured as described in the examples above with respect to the one or more processors 402 and/or memory 403 of UE 415.

In an example, the one or more processors 452 and/or memory 453 may execute actions or operations defined by control channel component 302 or its subcomponents. For instance, the one or more processors 452 and/or memory 453 may execute actions or operations defined by a search space defining component 460 for defining one or more parameters corresponding to a control channel search space, such as a CSS, DESS, etc. In an aspect, for example, search space defining component 460 may include hardware (e.g., one or more processor modules of the one or more processors 452) and/or computer-readable code or instructions stored in memory 453 and executable by at least one of the one or more processors 452 to perform the specially configured search space defining operations described herein. Further, for instance, the one or more processors 452 and/or memory 453 may execute actions or operations defined by a search space parameter component 462 for communicating one or more parameters related to performing blind decoding of the control channel search space to improve efficiency of the blind decoding. In an aspect, for example, search space parameter component 462 may include hardware (e.g., one or more processor modules of the one or more processors 452) and/or computer-readable code or instructions stored in memory 453 and executable by at least one of the one or more processors 452 to perform the specially configured search space parameter communicating operations described herein.

In an example, transceivers 404, 454 may be configured to transmit and receive wireless signals through one or more antennas 464, 466 and may generate or process the signals using one or more RF front end components (e.g., power amplifiers, low noise amplifiers, filters, analog-to-digital converters, digital-to-analog converters, etc.), one or more transmitters, one or more receivers, etc. In an aspect, the transceivers 404, 454 may be tuned to operate at specified frequencies such that the UE 415 and/or the access point 405 can communicate at a certain frequency. In an aspect, the one or more processors 402, 452 may configure the transceivers 404, 454 to operate at a specified frequency and power level based on a configuration, a communication protocol, etc.

In an aspect, the transceivers 404, 454 can operate in multiple bands (e.g., using a multiband-multimode modem, not shown) to process digital data sent and received using the transceivers 404, 454. In an aspect, the transceivers 404, 454 can be multiband and be configured to support multiple frequency bands for a specific communications protocol. In an aspect, the transceivers 404, 454 can be configured to support multiple operating networks and communications protocols. Thus, for example, the transceivers 404, 454 may enable transmission and/or reception of signals based on a specified modem configuration.

Referring to FIG. 5, an example of a method 500 is illustrated for transmitting (e.g., by an eNB or other access point) one or more control channels in a control channel search space, such as a CSS, UESS, etc. In method 500, blocks indicated as dashed boxes represent optional steps.

In an example, method 500 includes, at Block 502, configuring one or more parameters related to a number of blind decodes for a control channel search space for a UE. In an aspect, a search space defining component 460, e.g., in conjunction with the processor(s) 452, memory 453, and/or access point transceiver 454, can configure the one or more parameters related to the number of blind decodes for the control channel search space for the UE. For example, the search space defining component 460 can configure one or more parameters including an aggregation level, a number of control channel candidates, a number of control channel sizes (e.g., per candidate), possible DCI formats for the control channel, and/or the like. In one example, configuring the one or more parameters can include communicating the one or more parameters to one or more UEs (e.g., using radio resource control (RRC) layer signaling) to allow the one or more UEs to perform blind decoding over the control channel search space based on the one or more parameters. For example, the parameters may apply across one or more scheduling combinations (e.g., downlink self-scheduling, uplink cross-carrier scheduling, etc.).

For example, in LTE, the control channel search space may include a CSS for multiple UEs and/or a UESS specific to one or more UEs. The UESS may include a number of control channel candidates per each of multiple aggregation levels (e.g., control channel element (CCE) aggregation level), and each control channel candidate may include a number of possible control channel sizes. For example, search space defining component 460 may define the control channel search space based on the following parameters:

| | Number of | |
|---|---|---|
| | candidates per | Number of |
| Aggregation | aggregation | sizes to search |
| Level | level | per candidate |
| 1 | 6 | 2 or 3 |
| 2 | 6 | 2 or 3 |
| 4 | 2 | 2 or 3 |
| 8 | 2 | 2 or 3 |

| | |
|---|---|
| Total number of blind | 32 or 48 |
| decodes | (with UL MIMO) |

Thus, for example, a UE performing blind decoding of the search space may search multiple control channel sizes (2 or 3) for each size candidate at each aggregation level.

In addition, search space defining component 460 can define the one or more parameters as including one or more DCI formats that may be used for each control channel candidate in the control channel search space (e.g., DCI format 0A, 0B, 1A, 2B, 4A, 4B, etc., as defined in LTE). For example, in LTE (e.g., specifically in licensed assisted access (LAA) LTE), DCI format 0A and 4A can be defined as default DCI formats for uplink (UL) scheduling for a SCell (e.g., when transmission mode 2 (TM2) is configured), though these DCI formats may be disabled for each SCell by an access point using RRC signaling. Thus, for example, usage of DCI format 0B and 4B can be configurable for an SCell in LAA by an access point using RRC signaling. In any case, in LTE LAA, there may be at least 6 candidates for DCI format in the control channel search space that are to be monitored in performing blind decoding (e.g., 2B, 1A, 0A, 0B, 4A, and 4B). Accordingly, the number of blind decodes that need to be performed by a UE over a defined search space may increase as the number of possible DCI formats increase, the number of aggregation levels increase, the number of control channel candidates per aggregation level increase, the number of possible control channel sizes per control channel candidate increase, etc.

Method 500 also includes, at Block 504, indicating one or more reduction values for the number of blind decodes. In an aspect, a search space parameter component 462, e.g., in conjunction with the processor(s) 452, memory 453, and/or access point transceiver 454, can indicate the one or more reduction values for the number of blind decodes (e.g., to UE 415). This can result in reduction of complexity of the blind decoding at the UE 415. In one example, search space parameter component 462 can signal an indicator to the UE 415 indicating a reduction value, such as a 2-bit indicator where the combination of bits can be used to specify a 0, 0.33, 0.66, or 1 reduction value in the number of control channel candidates. In one example, search space parameter component 462 can signal (e.g., semi-statically) the 2-bit indicator per aggregation level per component carrier for a number of PDCCH or EPDCCH candidates in a UE-specific search space. In this specific example, the two bits can indicate a reduction for each of the nominal PDCCH or EPDCCH candidates in one or more sets of PDCCH and/or EPDCCH candidates. Where two EPDCCH sets are configured, the reduction can be applied to each set separately. In any case, this can result in a similar reduction in the number of blind decodes to be performed by the UE 415. For example, the indication can specify the reduction to include the first N control channel candidates, where N=round {total number of control channel candidates*reduction value}. In total, in the specific example above, up to 2×5 bits=10 bits ((1, 2, 4, 8), (1, 2, 4, 8, 16), (2, 4, 8, 16, 32)) can be configured. Additionally, per-component carrier enabling/disabling of monitoring of DCI format 0A and 1A can be configured by the access point via the search space parameter component 462.

In one example, control channel component 302 can receive a blind decode capability indicator for the UE 415 (e.g., from the UE 415), which can specify blind decoding capability of the UE for UE-specific search spaces per subframe (e.g., 32 values indicating the number of blind decodes supported by the UE per subframe, which can be given by 32*[5, . . . , 32], with 4 values reserved for future use). The capability can be independent of UE category, band combination, etc. If the UE 415 does not indicate a blind decode capability, access point 405 can assume all blind decode candidates are supported by the UE 415, and can accordingly transmit a control channel based on this assumption, as described further herein. Where reduction is requested, for example, search space parameter component 462 can specify the reduction value based on the blind decode capability indicator for the UE 415, in one example. Moreover, in an example, search space parameter component 462 can specify the reduction value for the number of control channel candidates per one or more DCI formats.

For example, in LTE LAA, an RRC signaling, pdcch-candidateAdjustment, transmitted by an access point, can be used to adjust a number of blind decodes for a UE-specific search space for each of the DCI formats for scheduling each carrier. In this example, search space parameter component 462 can transmit the parameter to specify a reduction value (e.g., 0, 0.33, 0.66, 1) for DCI formats 0A and [4A or 0B] for each aggregation level. In another example, in LTE LAA, search space parameter component 462 can transmit the parameter to specify a reduction value (e.g., 0, 0.33, 0.66, 1) for DCI formats [0B or 4A] and 4B for a first and second aggregation level, and another reduction value (e.g., 0, [0.5 or 0.66], 1.00, [1.50 or 2.00], etc.) for a third, fourth, and fifth aggregation level. In an example, an RRC signaling, pdcch-candidateReductions, transmitted by the access point, can apply for other DCI formats, and if pdcch-candidateAdjustment is not configured, pdcch-candidateReductions can apply to all DCI formats.

Referring to FIG. 5, method 500 also includes, at Block 506, indicating one or more additional parameters related to a pattern for performing a subset of the number of blind decodes based at least in part on the one or more reduction values. In an aspect, the search space parameter component 462, e.g., in conjunction with the processor(s) 452, memory 453, and/or access point transceiver 454, can indicate the one or more additional parameters related to the pattern for performing the subset of the number of blind decodes based at least in part on the one or more reduction values. In one example, search space parameter component 462 can specify an offset value for offsetting a linear arrangement of the reduced number of blind decodes. For example, at aggregation level 1 where 6 candidates of the control channel search space can be monitored by the UE 415 at two DCI formats (e.g., 0A and 0B), a possible linear arrangement of reduced number (6) of blind decodes may include (0A, 0A, 0A, 0B, 0B, 0B). Thus, where the offset value is 2, for example, this can indicate to perform the blind decodes in the order (0A, 0B, 0B, 0B, 0A, 0A). This can result in randomizing the control channel search space to some extent to minimize blocking for a given DCI format. In another example, search space parameter component 462 can specify an explicit order in which to arrange the DCI formats linearly (e.g., (0A, 0A, 0A, 0B, 0B, 0B), (0A, 0A, 4A, 4A, 4B, 4B), etc.). Moreover, for example, the number of candidates for each DCI format can be different, as described based on different reduction values for each DCI format. Thus, a linear arrangement may similarly be (0A, 0A, 0A, 0A, 0B, 0B), and the offset value, order, etc. can be similarly applied to such arrangements to generate the pattern.

Method 500 also includes, at Block 508, transmitting a control channel in the control channel search space based on a DCI format corresponding to at least one of the subset of the number of blind decodes. In an aspect, a control channel component 302, e.g., in conjunction with the processor(s) 452, memory 453, and/or access point transceiver 454, can transmit the control channel in the control channel search space based on the DCI format corresponding to at least one of the subset of the number of blind decodes. For example, control channel component 302 may select a DCI format with a size and/or structure to effectively communicate downlink control data to the UE 415. In an aspect, control channel component 302 may select a control channel candidate based on the one or more reduction values, as described (e.g., one of first N control channel candidates). In any case, control channel component 302 can generate the control channel using the candidate and/or DCI format, and can transmit the control channel in the control channel search space (e.g., over a frequency band in one or more symbols). As described further herein, the UE 415 can monitor the control channel search space based on a number (e.g., a reduced number based on the one or more reduction values) of blind decodes, and can accordingly attempt to decode the control channel.

Method 500 can optionally include, at Block 510, assigning a plurality of RNTIs related to a plurality of DCI formats corresponding to the subset of the number of blind decodes. In an aspect, the search space defining component 460, e.g., in conjunction with the processor(s) 452, memory 453, and/or access point transceiver 454, can assign the plurality of RNTIs related to the plurality of DCI formats corresponding to the subset of the number of blind decodes. For example, the search space defining component 460 can assign RNTIs to the UE 415, where the RNTIs are used to mask control channel communications transmitted in the control channel search space to allow the UE to determine whether the control channel is properly received (e.g., by demasking based on the RNTIs and determining whether the CRC passes). In this example, search space defining component 460 can assign a plurality of RNTIs to the UE to differentiate DCI formats, where the DCI formats can be split between the plurality of RNTIs. For example, search space defining component 460 can assign DCI formats related to downlink grants to one RNTI and DCI formats related to uplink grants to another RNTI. UE 415 can accordingly determine the corresponding RNTIs and can determine possible DCI formats for control channel communications based on which RNTI is used to successfully demask the blind decoding candidate. Moreover, in an example, search space defining component 460 can assign a first RNTI to the UE 415, and mask one or more additional RNTIs for the UE 415 by the first RNTI to allow the UE 415 to derive the plurality of RNTIs based on the first RNTI.

Referring to FIG. 6, an example of a method 600 is illustrated for performing (e.g., by a UE) blind decoding of a control channel search space. In the method 600, blocks indicated as dashed boxes represent optional steps.

In an example, the method 600 includes, at Block 602, determining a number of blind decodes configured for a control channel search space based at least in part on one or more parameters broadcasted by an access point that transmits a control channel in the control channel search space. In an aspect, the search space configuring component 410, e.g., in conjunction with the processor(s) 402, memory 403, and/or UE transceiver 404, can determine the number of blind decodes configured for the control channel search space based at least in part on the one or more parameters broadcasted by the access point (e.g., access point 405 or other access point, base station, eNB, etc.) that transmits the control channel in the control channel search space. For example, search space configuring component 410 can determine the number of blind decodes based on one or more parameters configured at UE 415 (e.g., by access point 405 or otherwise) or otherwise broadcasted or transmitted by access point 405, such as an aggregation level, a number of control channel candidates per aggregation level, a possible control channel size for each of the control channel candidates, possible DCI formats for each of the control channel candidates, etc. In an example, search space configuring component 410 may determine a total number of blind decodes for the control channel search space given the one or more parameters, as described above.

In an example, determining the number of blind decodes at Block 602 may optionally include, at Block 604, determining the number of blind decodes based on at least one of a plurality of assigned RNTIs. In an aspect, the search space configuring component 410, e.g., in conjunction with the processor(s) 402, memory 403, and/or UE transceiver 404, can determine the number of blind decodes based on at least one of the plurality of assigned RNTIs. As described, for example, the access point 405 may assign separate RNTIs for different groups of DCI formats (e.g., one RNTI for DCI formats of downlink grants and another RNTI for DCI formats of uplink grants). Thus, search space configuring component 410 can determine the number of blind decodes corresponding one or more of the assigned RNTIs (e.g., which may be based on the number of possible DCI formats for the RNTI). In one example, search space configuring component 410 can use an assigned RNTI to demask other RNTIs in determining the RNTIs assigned to the UE 415 by the access point 405.

In an example, the method 600 includes, at Block 606, determining one or more reduction values for the number of blind decodes. In an aspect, the search space configuring component 410, e.g., in conjunction with the processor(s) 402, memory 403, and/or UE transceiver 404, can determine the one or more reduction values for the number of blind decodes. In an example, search space configuring component 410 may receive the one or more reduction values from the access point 405. In one example, the reduction value(s) may be sent by the access point 405 based on a request sent by the UE 415 to reduce the number of blind decoding candidates for the search space. For example, the request may include a request for reduced blind decoding and may indicate a capability of the UE 415 with respect to performing blind decoding (e.g., a number of blind decodes that the UE 415 can perform, a requested reduction value, etc.). In any case, search space configuring component 410 may receive the one or more reduction values, and the number of blind decodes can be accordingly reduced. For example, as described, the reduction values can correspond to a reduction in the number of control channel candidates per aggregation level, for a given DCI format, etc., which may also be indicated in the one or more reduction values. For example, the reduction values may indicate to consider a first N control channel candidates, where N=round {total number of control channel candidates*reduction value} in performing blind decoding of the control channel search space. In an example, access point 405 can transmit the reduction values in RRC signaling, as described.

Referring to FIG. 6, for example, the method 600 includes, at Block 608, determining a pattern for performing a subset of the number of blind decodes based at least in part on the one or more reduction values. In an aspect, a blind decode patterning component 412, e.g., in conjunction with the processor(s) 402, memory 403, and/or UE transceiver 404, can determine the pattern for performing the subset of the number of blind decodes based at least in part on the one or more reduction values. The subset of the number of blind decodes can correspond to the number of blind decodes as reduced based on the reduction values, as described above. The subset of the number of blind decodes is also referred to herein as the reduced number of blind decodes. For example, blind decode patterning component 412 may determine the pattern based at least in part on one or more parameters received from the access point 405 or otherwise based on instructions or parameters configured in the UE 415. For example, the pattern can correspond to an order by which to perform the reduced number of blind decodes of the control channel search space.

In an example, determining the pattern at Block 608 may optionally include, at Block 610, determining a linear arrangement of the subset of the number of blind decodes in the pattern based at least in part on a DCI format. In an aspect, the blind decode patterning component 412, e.g., in conjunction with the processor(s) 402, memory 403, and/or UE transceiver 404, can determine the linear arrangement of (e.g., and accordingly linearly arrange) the subset of the number of blind decodes in the pattern based at least in part on the DCI format. In a specific example, search space configuring component 410 can determine aggregation level 1 of the control channel search space, and six control channel candidates to monitor using blind decoding. In this example, search space configuring component 410 may also be configured with two possible DCI formats (0A, 0B), and also a reduction in the number of blind decodes for each DCI format, such that there may be three control channel candidates for DCI format 0A and three control channel candidates for DCI format 0B. In this example, blind decode patterning component 412 may determine a linear arrangement of the reduced number of blind decodes as three candidates of DCI format 0A followed by three candidates of DCI format 0B (0A, 0A, 0A, 0B, 0B, 0B) for performing blind decoding of the control channel search space. Similarly, in an example, search space configuring component 410 may be configured with different reduction values for the DCI formats, which may result in four control channel candidates for DCI format 0A and two control channel candidates for DCI format 0B, in one specific example. Thus, for example, blind decode patterning component 412 may determine the arrangement of the number of blind decodes as the four candidates of DCI format 0A followed by the two candidates of DCI format 0B.

In another example, determining the pattern at Block 608 may optionally include, at Block 612, offsetting the linear arrangement of the subset of the number of blind decodes based on a configured offset value. In an aspect, the blind decode patterning component 412, e.g., in conjunction with the processor(s) 402, memory 403, and/or UE transceiver 404, can offset the linear arrangement of the subset of the number of blind decodes based on a configured offset value. For example, the configured offset value can be received from the access point 405 in a configuration (e.g., RRC signaling), as described. In any case, blind decode patterning component 412 can accordingly offset the linearly arranged pattern by the offset value. In the specific examples above, given an offset value of two, blind decode patterning component 412 can offset the linear arrangement of (0A, 0A, 0A, 0B, 0B, 0B) to (0A, 0B, 0B, 0B, 0A, 0A), or the linear arrangement of (0A, 0A, 0A, 0A, 0B, 0B) to (0A, 0A, 0B, 0B, 0A, 0A) for performing the blind decoding.

In another example, determining the pattern at Block 608 may optionally include, at Block 614, ordering the subset of the number of blind decodes based on a configured indication of an order. In an aspect, the blind decode patterning component 412, e.g., in conjunction with the processor(s) 402, memory 403, and/or UE transceiver 404, can order the subset of the number of blind decodes based on the configured indication of the order. In an example, the access point 405 can signal one or more parameters related to the order, such as a parameter explicitly indicating the order of candidates to use in performing the blind decoding, and blind decode patterning component 412 can accordingly order the subset of the number of blind decodes based on the configured order.

In another example, determining the pattern at Block 608 may optionally include, at Block 616, determining to interleave the subset of the number of blind decodes based on associated DCI format. In an aspect, the blind decode patterning component 412, e.g., in conjunction with the processor(s) 402, memory 403, and/or UE transceiver 404, can determine to interleave (and can accordingly interleave) the subset of the number of blind decodes based on associated DCI format. For example, blind decode patterning component 412 may evenly interleave the subset of the number of blind decodes or otherwise interleave such to minimize adjacent DCI formats in the blind decoding attempts (which can minimize probability of blocking a certain DCI format). In the specific example above, where three control channel candidates are configured for DCI format 0A and three control channel candidates are configured for DCI format 0B, blind decode patterning component 412 may interleave the subset of the number of blind decodes are (0A, 0B, 0A, 0B, 0A, 0B). In another specific example above, where four control channel candidates are configured for DCI format 0A and two control channel candidates are configured for DCI format 0B, blind decode patterning component 412 may interleave the subset of the number of blind decodes are (0A, 0A, 0B, 0A, 0A, 0B). Where there are two or more possible solutions to maximize separation of the same DCI formats, for example, blind decode patterning component 412, in this example, may select the solution having contiguous number of candidates in decreasing order from the first blind decode to the last blind decode.

In another example, determining the pattern at Block 608 may optionally include, at Block 618, determining patterns for performing subsets of numbers of blind decodes in each of multiple sets of DCI formats. In an aspect, the blind decode patterning component 412, e.g., in conjunction with the processor(s) 402, memory 403, and/or UE transceiver 404, can determine the patterns for performing subsets of numbers of blind decodes in each of the multiple sets of DCI formats. For example, multiple sets of DCI formats can be configured for a given aggregation level. In a specific example, for aggregation level 1, 12 candidates can be possible based on the table above, and the candidates can be divided into two sets (e.g., downlink DCI formats (0A, 0B, 0A, 0B, 4A, 4B, 4A, 4B) and uplink DCI formats (2B, 2B, 1A, 1A), as configured by the access point 405). In this example, blind decode patterning component 412 can determine patterning for each of the two sets, as described above. In an example, access point 405 can signal configuration of the sets, the DCI formats in each set, type of arrangement in each set, etc. to the UE 415.

In addition, for example, the method 600 includes, at Block 620, performing blind decoding for the control channel based on the pattern for performing the subset of the number of blind decodes to obtain control data transmitted in the control channel. In an aspect, a blind decoding component 414, e.g., in conjunction with the processor(s) 402, memory 403, and/or UE transceiver 404, can perform blind decoding for the control channel based on the pattern for performing the subset of the number of blind decodes to obtain control data transmitted in the control channel. As described, for example, performing the blind decoding can include attempting to decode the control channel in the search space by using the blind decoding candidates as determined by the blind decode patterning component 412 (e.g., an in an order, pattern, etc. defined by the blind decode patterning component 412). Where decoding using the first blind decoding candidate does not succeed, blind decoding component 414 can attempt to decode the control channel using the next blind decoding candidate, and so on until successful decoding of the control channel is achieved.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for wireless communication by a user equipment (UE), comprising:
determining a number of blind decodes configured for a control channel search space based at least in part on one or more parameters broadcasted by an access point that transmits a control channel in the control channel search space;
determining one or more reduction values for the number of blind decodes at the UE;
determining a pattern for performing a subset of the number of blind decodes based at least in part on the one or more reduction values; and
performing, by the UE, blind decoding for the control channel based on the pattern for performing the subset of the number of blind decodes to obtain control data transmitted in the control channel.

2. The method of claim 1, further comprising receiving an offset value from the access point, wherein determining the pattern for performing the subset of the number of blind decodes comprises:
determining the pattern as a linear arrangement of the subset of the number of blind decodes based at least in part on a downlink control information (DCI) format of each of the subset of the number of blind decodes; and
offsetting the linear arrangement of the subset of the number of blind decodes based on the offset value.

3. The method of claim 1, further comprising receiving an indication of an order for the subset of the number of blind decodes from the access point, wherein determining the pattern for performing the subset of the number of blind decodes is based at least in part on the indication of the order.

4. The method of claim 1, wherein determining the pattern for performing the subset of the number of blind decodes comprises determining an interleave of the subset of the number of blind decodes in the pattern based on a downlink control information (DCI) format to alternate between at least two DCI formats of each of the subset of the number of blind decodes.

5. The method of claim 1, further comprising dividing the subset of the number of blind decodes into multiple sets based on a downlink control information (DCI) format associated with each of the subset of the number of blind decodes, wherein determining the pattern for performing the subset of the number of blind decodes comprises determining patterns for performing subsets of the number of blind decodes in each of the multiple sets.

6. The method of claim 5, wherein the multiple sets include a first set comprising blind decodes for downlink DCI formats and a second set comprising blind decodes for uplink DCI formats.

7. The method of claim 1, wherein determining the number of blind decodes is based at least in part on one of a plurality of radio network temporary identifiers (RNTI) assigned to the UE.

8. The method of claim 7, wherein the one of the plurality of RNTIs corresponds to one of downlink control channels or uplink control channels.

9. The method of claim 7, further comprising determining the one of the plurality of RNTIs based at least in part on masking another one of the plurality of RNTIs assigned to the UE.

10. The method of claim 1, wherein determining the number of blind decodes is based at least in part on receiving the number of blind decodes from the access point.

11. The method of claim 1, wherein determining the number of blind decodes comprises receiving the number of blind decodes from the access point, and wherein determining the one or more reduction values comprises receiving the one or more reduction values from the access point.

12. An apparatus for wireless communications, comprising:
a transceiver for communicating one or more wireless signals via one or more antennas;
a memory configured to store instructions; and
one or more processors communicatively coupled with the transceiver and the memory, wherein the one or more processors are configured to:
determine a number of blind decodes configured for a control channel search space based at least in part on one or more parameters broadcasted by an access point that transmits a control channel in the control channel search space;
determine one or more reduction values for the number of blind decodes at the UE;
determine a pattern for performing a subset of the number of blind decodes based at least in part on the one or more reduction values; and
perform blind decoding for the control channel based on the pattern for performing the subset of the number of blind decodes to obtain control data transmitted in the control channel.

13. The apparatus of claim 12, wherein the one or more processors are further configured to receive an offset value from the access point, and wherein the one or more processors are configured to determining the pattern for performing the subset of the number of blind decodes at least in part by:
determining the pattern as a linear arrangement of the subset of the number of blind decodes based at least in part on a downlink control information (DCI) format of each of the subset of the number of blind decodes; and
offsetting the linear arrangement of the subset of the number of blind decodes based on the offset value.

14. The apparatus of claim 12, wherein the one or more processors are further configured to receive an indication of an order for the subset of the number of blind decodes from the access point, wherein the one or more processors are configured to determine the pattern for performing the subset of the number of blind decodes based at least in part on the indication of the order.

15. The apparatus of claim 12, wherein the one or more processors are configured to determine the pattern for performing the subset of the number of blind decodes at least in part by determining an interleave of the subset of the number of blind decodes in the pattern based on a downlink control information (DCI) format to alternate between at least two DCI formats of each of the subset of the number of blind decodes.

16. The apparatus of claim 12, wherein the one or more processors are further configured to divide the subset of the number of blind decodes into multiple sets based on a downlink control information (DCI) format associated with each of the subset of the number of blind decodes, wherein the one or more processors are configured to determine the pattern for performing the subset of the number of blind decodes at least in part by determining patterns for performing subsets of the number of blind decodes in each of the multiple sets.

17. A method for wireless communication by an access point, comprising:
configuring one or more parameters related to a number of blind decodes for a control channel search space for a user equipment (UE);
indicating one or more reduction values for the number of blind decodes;
indicating one or more additional parameters related to a pattern for performing a subset of the number of blind decodes based at least in part on the one or more reduction values; and
transmitting a control channel in the control channel search space based on a downlink control information (DCI) format corresponding to at least one of the subset of the number of blind decodes.

18. The method of claim 17, wherein the one or more additional parameters relate to an offset value for offsetting a linear arrangement of the pattern for performing the subset of the number of blind decodes.

19. The method of claim 17, wherein the one or more additional parameters relate to an indication of an order for the pattern for performing the subset of the number of blind decodes.

20. The method of claim 17, wherein configuring the one or more parameters comprises transmitting the one or more parameters to the UE.
